(19) United States
(12) Patent Application Publication
(10) Pub. No.: US 2008/0090609 A1
(43) Pub. Date: Apr. 17, 2008

(54) METHOD AND APPARATUS FOR MANAGING MEMOS

(75) Inventors: EDWARD WALTER, BOERNE, TX (US); LARRY B. PEARSON, SAN ANTONIO, TX (US)

Correspondence Address: AKERMAN SENTERFITT, P.O. BOX 3188, WEST PALM BEACH, FL, 33402-3188, US

(73) Assignee: AT&T KNOWLEDGE VENTURES, L.P., RENO, NV (US)

(21) Appl. No.: 11/549,399

(22) Filed: Oct. 13, 2006

(51) Int. Cl. H04M 1/00

(52) U.S. Cl. 455/556.2

(57) ABSTRACT

A method and apparatus for managing memos is disclosed. An apparatus that incorporates teachings of the present disclosure may include, for example, a terminal device having User Interface (UI) element that presents a plurality of Graphical User Interface (GUI) elements each associated with one among a plurality of GUI categories, and a memo element that links a generated memo with a select GUI element of the plurality of GUI categories. Additional embodiments are disclosed.

### FIELD OF THE DISCLOSURE

The present disclosure relates generally to memo construction techniques and more specifically to a method and apparatus for managing memos.

### BACKGROUND

A memo generation application is generally available in computing devices, Personal Digital Assistants (PDAs) such as organizers as well as mobile and fixed line communication devices. Memos are generated for any number of reasons such as recording pending activities of an end user (e.g., grocery list), reminders of events ideas and/or concepts while the end user is in transit, and so on. Often generated memos are stored in a memorandum filing system which is organized sequentially according to their entry date, or scattered throughout a device's filing system as directed by the end user, which makes it difficult for said user to manage memos effectively.

A need therefore arises for a method and apparatus for managing memos.

### BRIEF DESCRIPTION OF THE DRAWINGS

FIG. 1 depicts an exemplary embodiment of a terminal device;

FIG. 2 depicts an exemplary method operating in the terminal device;

FIGS. 3-12 depict exemplary embodiments of the terminal device for managing memos; and

FIG. 13 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a method and apparatus for managing memos.

In a first embodiment of the present disclosure, a terminal device can have User Interface (UI) element that presents a plurality of Graphical User Interface (GUI) elements each associated with one among a plurality of GUI categories, and a memo element that links a generated memo with a select GUI element of the plurality of GUI categories.

In a second embodiment of the present disclosure, a computer-readable storage medium in a terminal device can have computer instructions for linking a generated memo with a select GUI element associated with one among a plurality of GUI categories presented by the terminal device.

In a third embodiment of the present disclosure, a method can have the step of linking a memo generated in a telephony device with a select GUI element associated with one among a plurality of GUI categories presented by the telephony device.

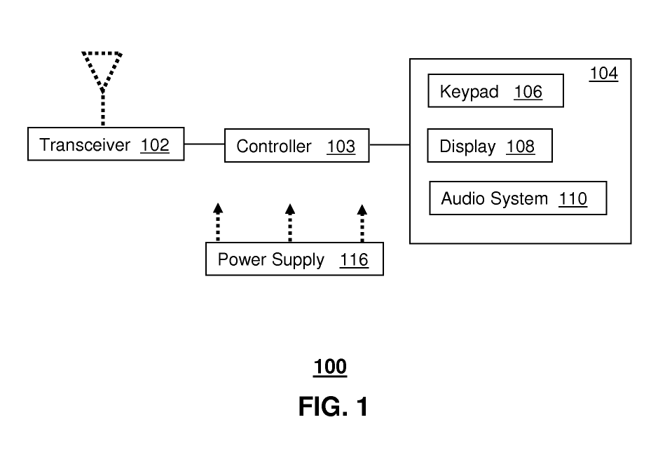

FIG. 1 depicts an exemplary embodiment of a terminal device 100. The terminal device 100 can comprise a wireless or wireline transceiver 102, a user interface (UI) 104, a power supply 116, and a controller 103 for managing operations of the foregoing components. The transceiver 102 can utilize common communication technologies to support singly or in combination any number of wireline access technologies such as cable, xDSL, Public Switched Telephone Network (PSTN), and so on.

Singly or in combination with the wireline technology, the transceiver 102 can support singly or in combination any number of wireless access technologies including without limitation Bluetooth™, Wireless Fidelity (WiFi), Worldwide Interoperability for Microwave Access (WiMAX), Ultra Wide Band (UWB), software defined radio (SDR), and cellular access technologies such as CDMA-1×, W-CDMA/HSDPA, GSM/GPRS, TDMA/EDGE, and EVDO. SDR can be utilized for accessing public and private communication spectrum with any number of communication protocols that can be dynamically downloaded over-the-air to the terminal device 100. It should be noted also that next generation wireline and wireless access technologies can also be applied to the present disclosure.

The UI element 104 can include a keypad 106 with depressible or touch sensitive keys and a navigation element such as a navigation disk, button, roller ball, or flywheel for manipulating operations of the terminal device 100. The UI element 104 can further include a display 108 such as monochrome or color LCD (Liquid Crystal Display) which can be touch sensitive for manipulating operations and for conveying images to the end user of the terminal device 100, and an audio system 110 that utilizes common audio technology for conveying and intercepting audible signals of the end user.

The power supply 116 can utilize common power management technologies such as replaceable batteries, supply regulation technologies, and charging system technologies for supplying energy to the components of the terminal device 100 and to facilitate portable applications. Depending on the type of power supply 116 used, the terminal device 100 can represent an immobile or portable communication device. The controller 103 can utilize computing technologies such as a microprocessor and/or digital signal processor (DSP) with associated storage memory such a Flash, ROM, RAM, SRAM, DRAM or other like technologies for controlling operations of the terminal device 100.

The terminal device 100 can further represent a single operational device or a family of devices configured in a master-slave arrangement. In the latter embodiment, the components of the terminal device 100 can be reused in different form factors for the master and slave terminal devices.

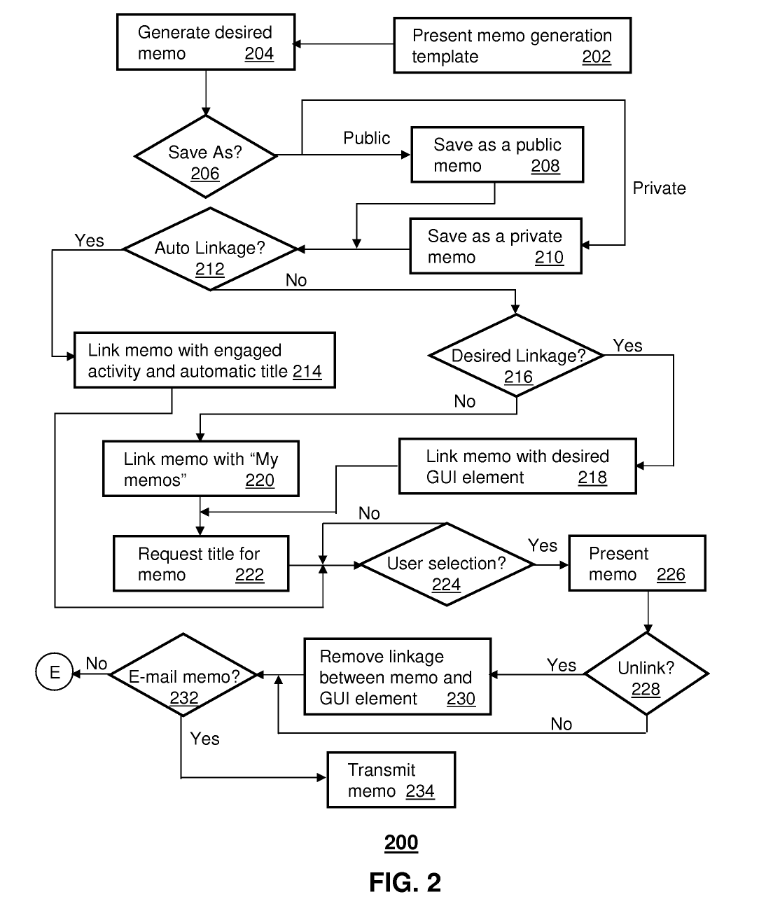

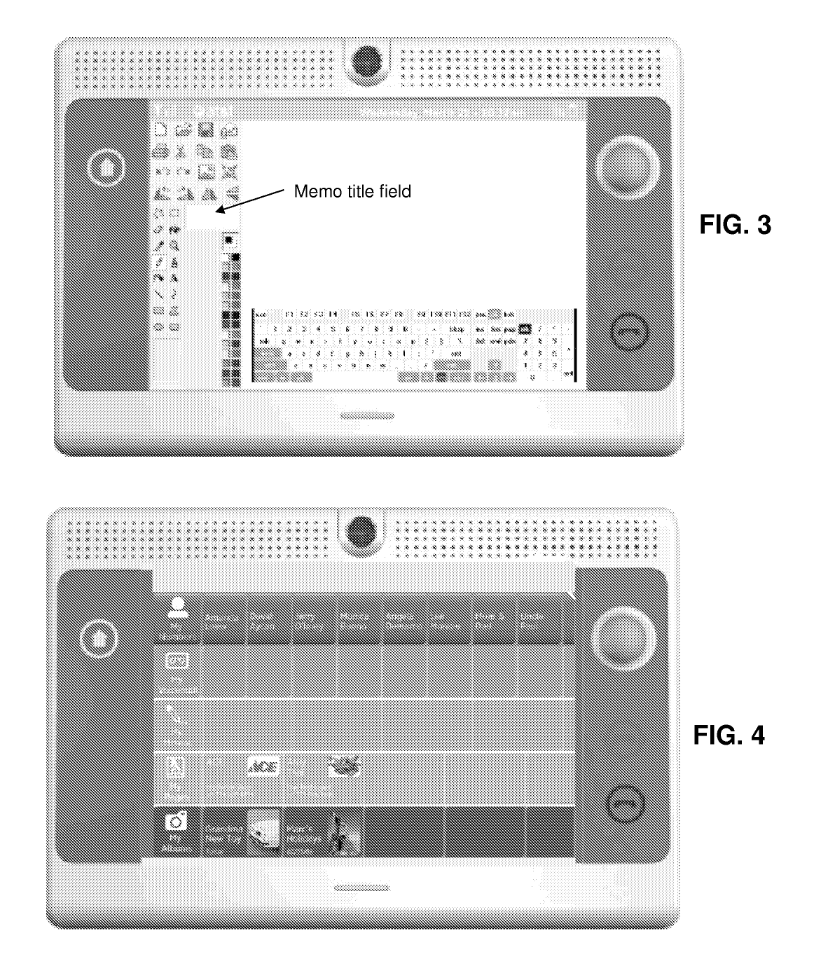

FIG. 2 depicts an exemplary embodiment of a method 200 operating in the terminal device 100. Method 200 begins with step 202 in which an end user of the terminal device 100 is presented a memo generation template such as shown in FIG. 3. The memo generation template can be generated by selecting a GUI element for memos such as shown in the “My Memo” GUI category of FIG. 4, or by selecting a GUI element of another GUI category such as “My Numbers” (i.e., contact book listings), “My Voicemail,” “My Pages” (e.g., directory listings such as from Yellow Pages™), “My Albums,” and so on.

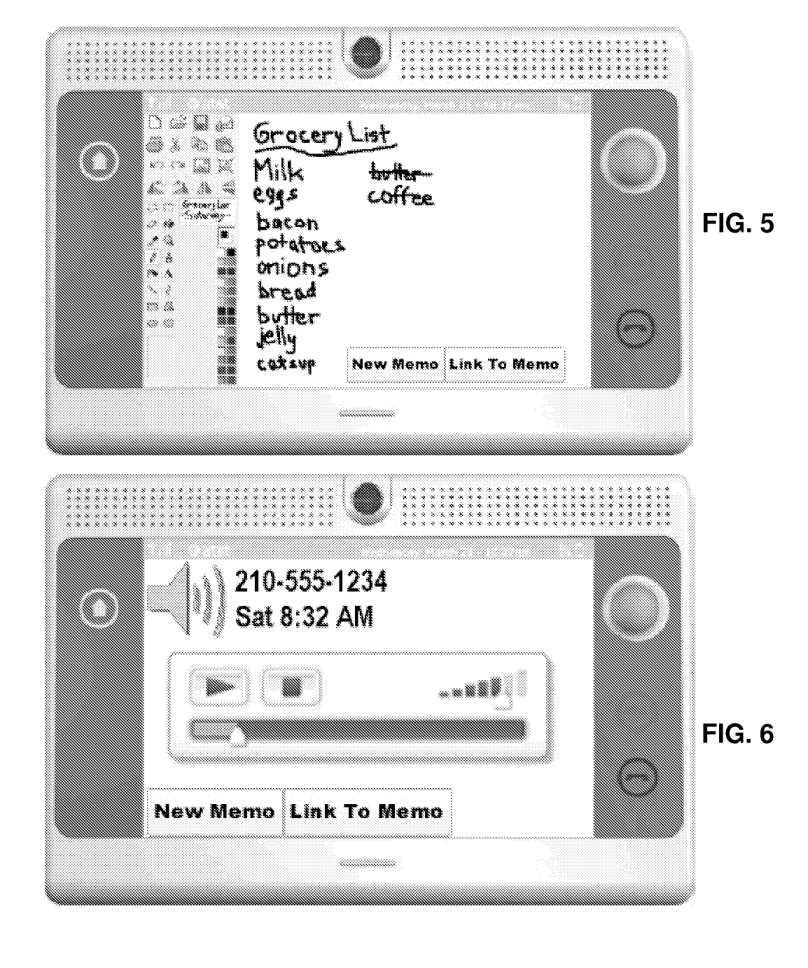

By selecting a GUI element from any of these GUI categories, a GUI button such as “New Memo” shown in FIG. 5 can be presented with the window associated with the GUI element selected to facilitate creating a memo. For example, while viewing a window associated with the GUI element depicting the caption “ACE” in the “My Pages” GUI category of FIG. 4, a “New Memo” GUI button can be presented along with the content associated with the window opened. Thus the end user selecting ACE GUI element can generate a memo to jot down ideas, reminders, or other useful information.

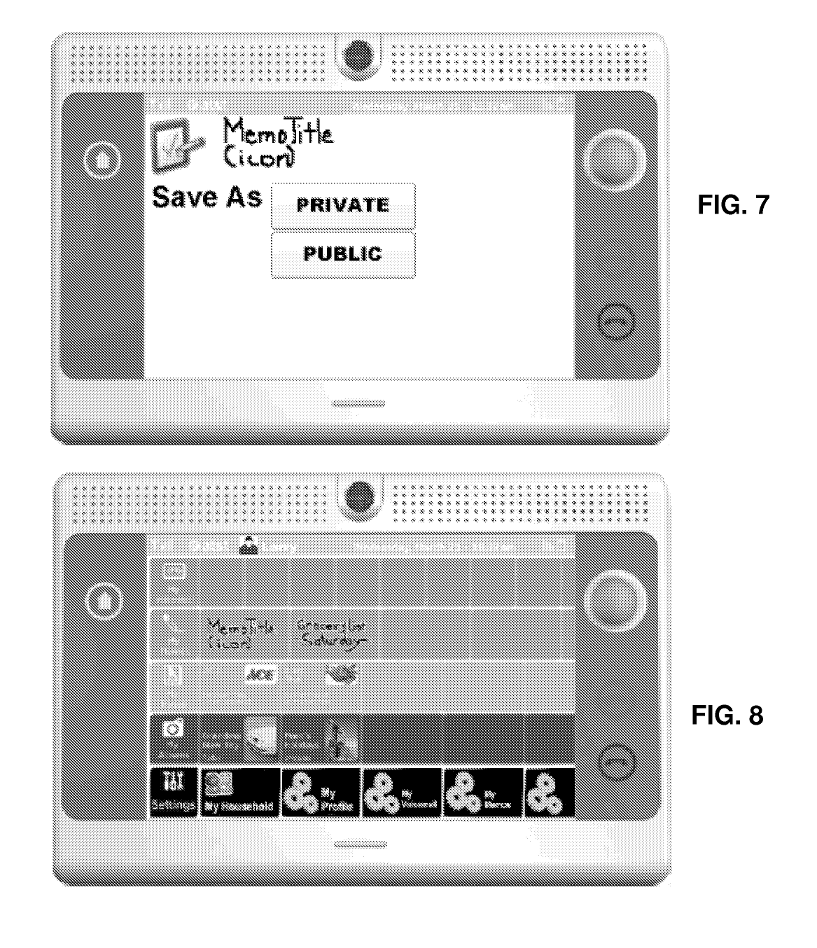

The memo generation template can be used by an end user to create handwritten notes with a stylus or a soft keypad which can be readily be enabled or disabled as desired from a selection in the template. Additionally, the template can provide means for drawing figures, importing still or moving images, and creating audio memos. A text memo can, for example, look something like the handwritten memo of FIG. 5. Alternatively, or in combination the memo can include an audio portion recorded by the end user by way of the audio system 110 of the UI element 104. Once a memo is generated in step 204 as depicted in FIGS. 5 and/or 6 by way of the memo generation template shown in FIG. 3, the terminal device 100 proceeds to step 206 where the user selects options for saving the memo. In a multi-user environment in which the terminal device 100 is shared by more than one user, the end user generating the memo can choose to save the memo as a public access memo accessible in step 208 to all or a portion of the users sharing the terminal device, or a private access memo accessible in step 210 to only the user creating said memo. The terminal device 100 can be directed by the end user to store a public or private memo by selecting one of two GUI buttons associated with each option as shown in FIG. 7.

In step 212 the terminal device 100 can be programmed to check for an auto linkage of the memo to a GUI element of a corresponding GUI category. For example, the end user of the terminal device 100 may have chosen to generate a memo while engaged in a communication session (e.g., a VoIP call or PSTN call) with a third party, while listening to voicemail, while viewing one or more received or dialed call logs, while processing a calendar entry, or while viewing an Internet web page (e.g., purchasing an item at an auctioning site). Any one of these activities as well as other possible activities not disclosed can be used to automatically link the memo generated with a GUI element associated with said activity.

For example, in the case of an active communication session, the terminal device 100 can be programmed in step 214 to automatically link the memo to a call log entry matching a caller ID of the calling party, or the party being called during said communication session. The association can be represented by superimposing an iconic symbol on the call log entry, and providing the memo an automatic title associated with said call (e.g., “Memo for call with xxx-yyy-zzzz”, or “Memo for call with John Doe”). Alternatively, the terminal device 100 can be programmed in step 214 to automatically link the memo to an entry in the contact book associated with a caller ID of the communication session.

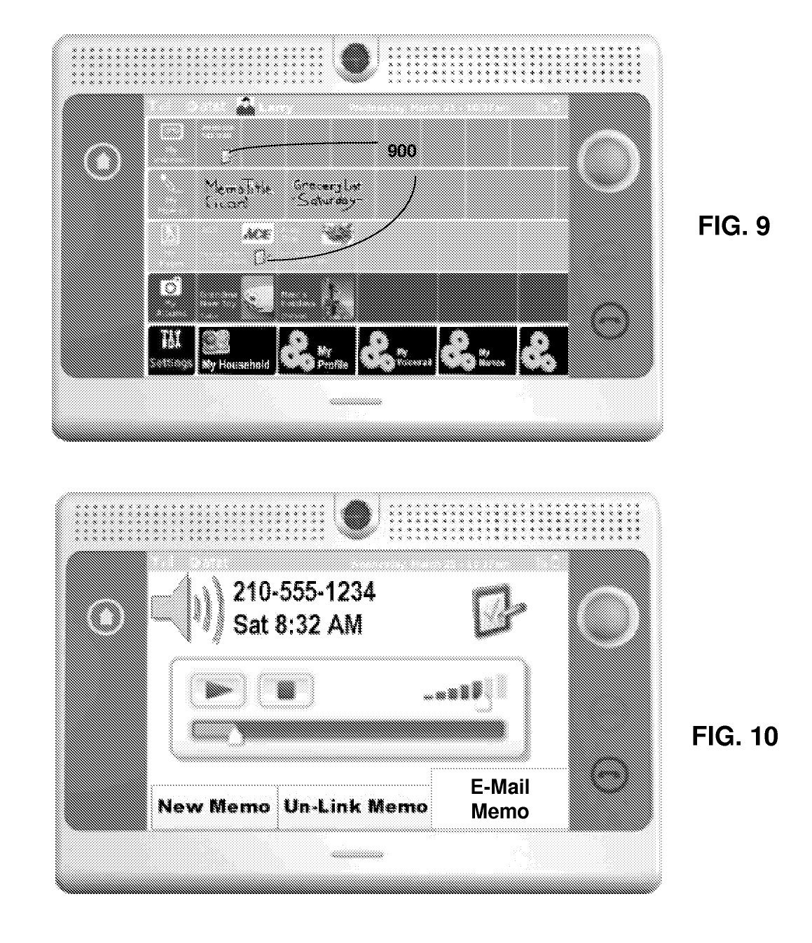

In yet another embodiment, the end user can select a GUI element of a GUI category such as the GUI element with the caption “ACE” (see FIG. 4) and initiate the generation of a memo by selecting a GUI button such as “New Memo” shown in the window associated with the GUI element selected. In this use case, the terminal device 100 proceeds to step 214 and links the memo with selected GUI element by superimposing the aforementioned iconic symbol on said GUI element. Additionally, in said step the terminal device 100 can be programmed to automatically generate a title for the memo based on the selected GUI element and/or the GUI category associated with said element. For example, the terminal device 100 can select a title such as “Memo for ACE,” which can be presented by the UI element 204 upon the end user selecting said memo by way of the iconic symbol for viewing purposes. Examples of the iconic symbol for a memo are shown by reference 900 of FIG. 9.

If on the other hand, the memo created in step 204 is not associated with one of the aforementioned activities, the terminal device proceeds to step 216 where it checks if the end user has provided a desired linkage. In this step, the terminal device 100 can present a memo to the end user with a GUI button depicted as “Link to Memo” such as shown in FIGS. 5 and 6. When this GUI button is selected, the end user can be presented a GUI window for browsing between the GUI categories of FIG. 4 to select a GUI element for associating to said memo. Once the user selects a desired linkage to a GUI element, the terminal device proceeds to step 218 where it links the memo to the desired GUI element. In step 222, the terminal device presents a field in the memo generation template to enter a title for the memo as shown in FIG. 3. The title can be handwritten with a stylus, or entered by way of the soft keyboard shown in FIG. 3.

Referring back to step 212, if there is no automatic linkage to one of the aforementioned activities, and the user has not selected a desired linkage to a GUI element, then the terminal device proceeds to step 220 where it links the generated memo to a GUI element of a memo GUI category depicted as “My Memos” in FIG. 4. The end user is in this case requested to enter a memo title as previously described. The titled memos are presented by the UI element 104 with their respective titles as shown in FIGS. 8 and 9.

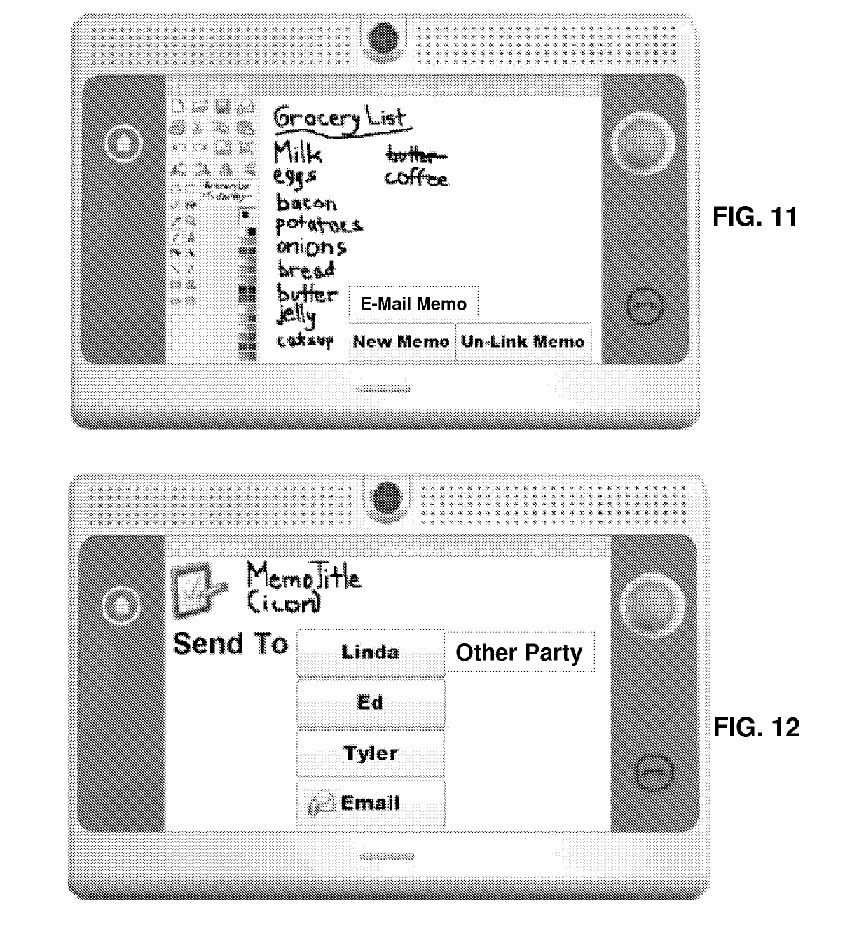

Once the generated memo has been linked to a select GUI element, the terminal device 100 proceeds to step 224 where it checks for a selection of the memo by the end user. The selection as previously described can be performed by selecting the iconic symbol 900 shown in FIG. 9, or by opening the associated GUI element and selecting the same iconic symbol for opening the memo. When such action is detected, the terminal device proceeds to step 226 where it presents the memo as depicted in FIG. 10 or 11. In this GUI window, the end user is presented with three GUI buttons to create yet another memo, unlink the memo from the associated GUI element, and/or to transmit by email the memo to a directed party. The terminal device 100 proceeds to step 230 in response to detecting in step 228 that the end user has selected to unlink the memo from the GUI element. In this step the GUI element can be disassociated by moving said memo to the “My Memos” GUI category.

In step 232 the terminal device 100 determines if the end user has selected the email GUI button for directing the memo to a select one of the users sharing the terminal device 100 or other third parties as depicted in FIG. 12. If such a selection is made and one or more email addresses are entered by the end user (except in cases where such information is already stored in the terminal device 100 such as in the contacts book), the terminal device proceeds to step 234 where it transmits the memo to one or more intended parties. Otherwise, the terminal device 100 ceases processing of the memo after step 232 and repeats the aforementioned steps of method 200 for new memos.

Upon reviewing the foregoing embodiments, it would be evident to an artisan with ordinary skill in the art that said embodiments can be modified, reduced, or enhanced without departing from the scope and spirit of the claims described below. There are innumerable GUI categories not discussed in the present disclosure. Thus, there are equally innumerable associations that can be made between a memo and a GUI element of a select GUI category. Similarly, there are numerous GUI element designs other than those shown in FIGS. 3-12 which a user can utilize to navigate and direct generation of memos and linkages of said memos to GUI elements. It would therefore be evident to said artisan that many modifications can be applied to the present disclosure without departing from the scope of the claims stated below. Accordingly, the reader is directed to the claims section for a fuller understanding of the breadth and scope of the present disclosure.

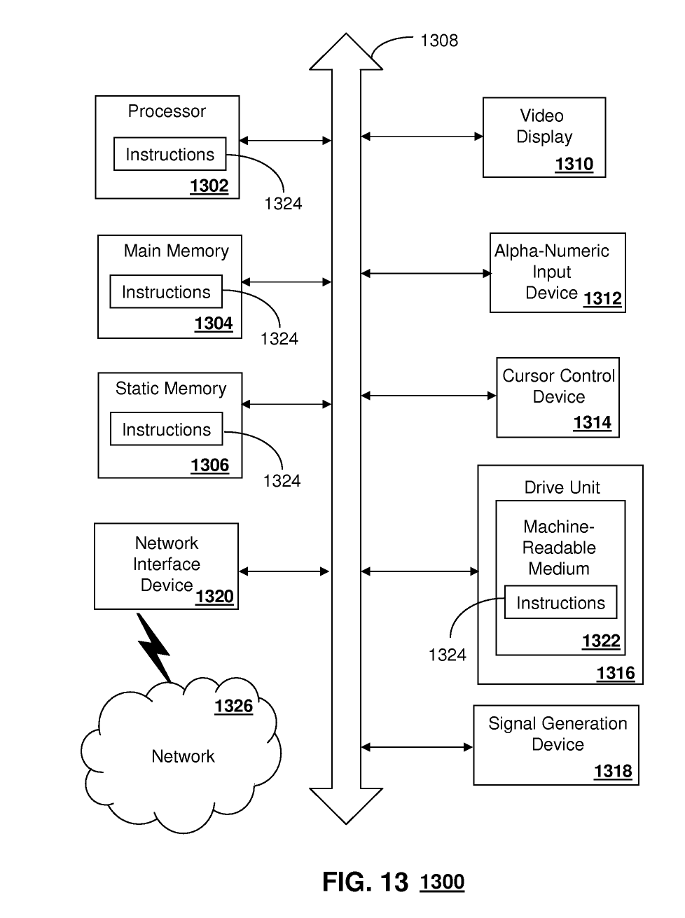

FIG. 13 depicts an exemplary diagrammatic representation of a machine in the form of a computer system 1300 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 1300 may include a processor 1302 (e.g., a central processing unit (CPU), a graphics processing unit (GPU, or both), a main memory 1304 and a static memory 1306, which communicate with each other via a bus 1308. The computer system 1300 may further include a video display unit 1310 (e.g., a liquid crystal display (LCD), a flat panel, a solid state display, or a cathode ray tube (CRT)). The computer system 1300 may include an input device 1312 (e.g., a keyboard), a cursor control device 1314 (e.g., a mouse), a disk drive unit 1316, a signal generation device 1318 (e.g., a speaker or remote control) and a network interface device 1320.

The disk drive unit 1316 may include a machine-readable medium 1322 on which is stored one or more sets of instructions (e.g., software 1324) embodying any one or more of the methodologies or functions described herein, including those methods illustrated above. The instructions 1324 may also reside, completely or at least partially, within the main memory 1304, the static memory 1306, and/or within the processor 1302 during execution thereof by the computer system 1300. The main memory 1304 and the processor 1302 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 1324, or that which receives and executes instructions 1324 from a propagated signal so that a device connected to a network environment 1326 can send or receive voice, video or data, and to communicate over the network 1326 using the instructions 1324. The instructions 1324 may further be transmitted or received over a network 1326 via the network interface device 1320.

While the machine-readable medium 1322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A terminal device, comprising:
a User Interface (UI) element that presents a plurality of Graphical User Interface (GUI) elements each associated with one among a plurality of GUI categories; and
a memo element that links a generated memo with a select GUI element of the plurality of GUI categories.

2. The terminal device of claim 1, wherein the memo element presents a memo template by way of the UI element to construct the generated memo.

3. The terminal device of claim 2, wherein the generated memo comprises at least one among an audio memo and a visual memo.

4. The terminal device of claim 3, wherein the visual memo comprises at least one among text, a still image and a moving image.

5. The terminal device of claim 1, wherein the UI element comprises at least one among a touch-screen display and a keypad from which an end user of the terminal device can direct linking of the generated memo to the selected GUI element.

6. The terminal device of claim 1, wherein each of the category of GUI elements comprises one among contact book listings, directory listings, task listings, memo listings, voicemail listings, call log listings, multimedia listings, news listings, weather listings, settings listings, and customized content listings.

7. The terminal device of claim 1, wherein the memo element presents a field for entering a title for the generated memo, and a directive GUI element for linking the generated memo to the selected GUI element.

8. The terminal device of claim 1, wherein the memo element generates a title for the generated memo according to at least one among the selected GUI element and the GUI category linked to the generated memo.

9. The terminal device of claim 1, wherein the UI element presents the generated memo and a directive GUI element for unlinking the generated memo from the selected GUI element.

10. The terminal device of claim 1, wherein the terminal device is shared with a plurality of users, and wherein the memo element saves as directed by a select one of the plurality of users the generated memo as one among a public access memo accessible to a portion or all of the plurality of users, and a private access memo accessible to only the select one of the plurality of users.

11. The terminal device of claim 10, wherein the memo element is directed by the select one of the plurality of users to transmit the private access memo by email to one among one or more of the plurality of users and one or more other users not sharing the terminal device.

12. The terminal device of claim 1, wherein the memo element is directed by a user to construct the generated memo while engaged in one among a communication session with a third party, listening to voicemail, viewing one or more call logs, processing a calendar entry, and viewing an Internet web page.

13. A computer-readable storage medium in a terminal device, comprising computer instructions for linking a generated memo with a select GUI element associated with one among a plurality of GUI categories presented by the terminal device.

14. The storage medium of claim 13, comprising computer instructions for:
presenting by way of a UI element a memo generation GUI element to an end user of the terminal device; and
presenting a memo template in response to a selection of the memo generation GUI element by the end user to construct the generated memo, wherein the generated memo comprises at least one among an audio memo and a visual memo, and wherein the visual memo comprises at least one among text, a still image and a moving image.

15. The storage medium of claim 13, wherein each of the category of GUI elements comprises one among contact book listings, directory listings, task listings, memo listings, voicemail listings, call log listings, multimedia listings, news listings, weather listings, settings listings, and customized content listings.

16. The storage medium of claim 13, comprising computer instructions for:
presenting a field for entering a title for the generated memo, and a directive GUI element for linking the generated memo to the selected GUI element; and
presenting the title of the generated memo in response to a user of said terminal device viewing the selected GUI element.

17. The storage medium of claim 13, comprising computer instructions for:
generating a title for the generated memo according to at least one among the selected GUI element and the GUI category linked to the generated memo; and
presenting an iconic symbol superimposed on the selected GUI element to indicate that the generated memo is associated with the selected GUI element.

18. The storage medium of claim 13, comprising computer instructions for:
presenting by way of a display of the terminal device the generated memo and a directive GUI element for unlinking the generated memo from the selected GUI element;
creating a GUI element for the unlinked generated memo; and
presenting said GUI element in a GUI category for memos only.

19. The storage medium of claim 13, wherein the terminal device is shared with a plurality of users, and wherein the storage medium comprises computer instructions for saving as directed by a select one of the plurality of users the generated memo as one among a public access memo accessible to a portion or all of the plurality of users, and a private access memo accessible to only the select one of the plurality of users.

20. The storage medium of claim 13, comprising computer instructions for constructing the generated memo while a user of the terminal device is engaged in one among a communication session with a third party, listening to voicemail, viewing one or more call logs, processing a calendar entry, and viewing an Internet web page.

21. The storage medium of claim 13, wherein the terminal device comprises one among a computer, a Personal Digital Assistant, a mobile communication device, and fixed line communication device.

22. A method, comprising linking a memo generated in a telephony device with a select GUI element associated with one among a plurality of GUI categories presented by the telephony device.
